(19) United States
(12) Patent Application Publication
(10) Pub. No.: US 2020/0011308 A1
(43) Pub. Date: Jan. 9, 2020

(54) SERVO REGULATOR

(71) Applicant: KYB Corporation, Tokyo (JP)

(72) Inventor: Takanori INADA, Tokyo (JP)

(73) Assignee: KYB Corporation, Tokyo (JP)

(21) Appl. No.: 16/482,484

(22) PCT Filed: Mar. 13, 2018
(86) PCT No.: PCT/JP2018/009820

§ 371 Date: Jul. 31, 2019

(30) Foreign Application Priority Data
Mar. 13, 2017 (JP) 2017-047564

(51) Int. Cl. F04B 1/32; F04B 1/20; F15B 7/00

(52) U.S. Cl. CPC F04B 1/324; F15B 7/00; F04B 1/2078

(57) ABSTRACT

A servo regulator includes a servo piston coupled with a swash plate, a pressure chamber provided to face an end portion of the servo piston, a spool configured to control a pressure in the pressure chamber by being moved by a solenoid, a biasing member configured to bias the spool against a thrust of the solenoid, and a feedback portion configured to change a biasing force of the biasing member in accordance with tilting of the swash plate, wherein the feedback portion is coupled with the swash plate via the servo piston.

### TECHNICAL FIELD

The present invention relates to a servo regulator.

### BACKGROUND ART

In a variable capacity piston pump (hereinafter referred simply as a “piston pump”) mounted on a vehicle such as a construction machine, a discharge flowrate of the piston pump is adjusted by transmitting displacement of the servo piston of a servo regulator to a swash plate of the piston pump so as to tilt the swash plate.

In the servo regulator disclosed in JP2009-243435A, the servo piston is displaced by a working oil supplied to a pressure chamber. The pressure chamber is connected to the pump through a port that is opened/closed by a spool. When the spool is moved by a thrust of a solenoid, the pressure chamber is connected to the pump through the port, and the working oil is supplied to the pressure chamber.

Moreover, in the servo regulator disclosed in JP2009-243435A, tilting of the swash plate is transmitted to a feedback spring via a feedback link. When a biasing force of the feedback spring is changed, the spool is moved so that the biasing force of the feedback spring is balanced with the thrust of the solenoid. As a result, a pressure in the pressure chamber is automatically adjusted so as to hold the servo piston at a desired position. As a result, a tilting angle of the swash plate of the variable capacity piston pump is maintained at a desired angle.

### SUMMARY OF INVENTION

In the servo regulator disclosed in JP2009-243435A, both the servo piston and the feedback link are coupled with an arm fixed to the swash plate of the piston pump. Thus, for assembling the servo regulator to the piston pump, the feedback link and the arm need to be coupled at the same time of coupling servo piston with the arm, which makes an assembling work complicated.

The present invention has an object to make assembling of the servo regulator to the piston pump easy.

The present invention relates to a servo regulator for controlling tilting of a swash plate of a variable volume piston pump. According to one aspect of the present invention, the servo regulator includes a servo piston slidably accommodated in a case and coupled with the swash plate, a pressure chamber provided to face an end portion of the servo piston, a spool configured to control a pressure in the pressure chamber by being moved by a solenoid, a biasing member configured to bias the spool against a thrust of the solenoid, and a feedback portion configured to change a biasing force of the biasing member in accordance with the tilting of the swash plate, wherein the feedback portion is coupled with the swash plate via the servo piston.

### BRIEF DESCRIPTION OF DRAWINGS

FIG. 1 is a sectional view of a servo regulator according to an embodiment of the present invention and illustrates a state where it is mounted on a variable capacity piston pump.

FIG. 2 is a partially sectional view of the servo regulator along II-II line in FIG. 1.

FIG. 3 is a partially enlarged sectional view illustrating peripheries of a first spool and a second spool and illustrates a state where a solenoid is not working.

FIG. 4 is a sectional view of the servo regulator and illustrates coupling between a servo piston and a feedback link correspondingly to FIG. 2.

FIG. 5 is a partially enlarged sectional view illustrating a periphery of a support shaft.

FIG. 6 is a partially enlarged sectional view illustrating the peripheries of a first spool and a second spool and illustrates a state where the solenoid is working.

FIG. 7 is a view for explaining an assembling method of the servo regulator and illustrates a state where the servo piston is coupled with a swash plate.

FIG. 8 is a view for explaining an assembling method of the servo regulator and illustrates a state where the feedback link is coupled with the servo piston.

FIG. 9 is a view for explaining the assembling method of the servo regulator and illustrates a state where the support shaft is inserted into a hole in a first case member.

### DESCRIPTION OF EMBODIMENTS

Hereinafter, a servo regulator 100 according to an embodiment of the present invention will be described by referring to the drawings.

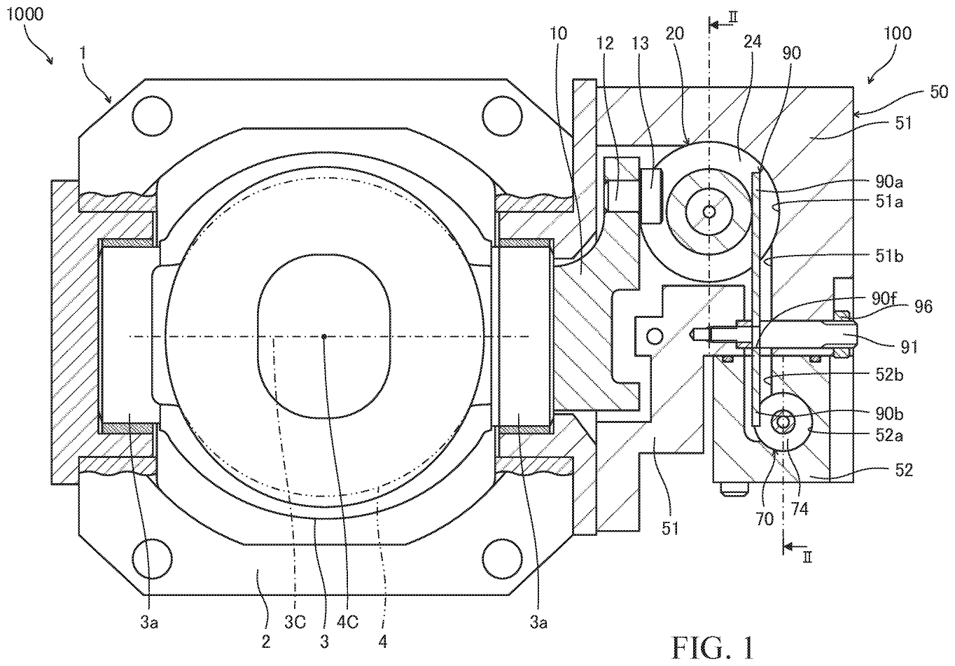

As illustrated in FIG. 1, a pump apparatus 1000 includes a variable capacity piston pump 1 and the servo regulator 100 assembled to the piston pump 1. The piston pump 1 is used for a hydrostatic continuously variable transmission (HST: Hydro Static Transmission) that supplies a working oil to a running hydraulic motor of a vehicle such as a construction machine.

The piston pump 1 includes a swash plate 3 provided capable of rotational movement in a housing 2 via a pair of trunnion shafts 3a and a cylinder block 4 that is rotated by power of an engine of the vehicle. A rotation center axis 4C of the cylinder block 4 crosses a rotational movement center axis 3C of the swash plate 3.

The cylinder block 4A is formed with a plurality of cylinders (not shown). The plurality of cylinders extends along the rotation center axis 4C of the cylinder block 4 and is disposed around the rotation center axis 4C.

A piston (not shown) is accommodated capable of sliding, and a capacity chamber is defined by the pistons in the cylinder. The capacity chamber alternatively communicates with a port for sucking and a port for discharge with rotation of the cylinder block 4.

One end of the piston is in contact with the swash plate 3 via a piston shoe (not shown). In a state where the swash plate 3 is tilted with respect to the rotation center axis 4C of the cylinder block 4, the piston is moved with respect to the cylinder block 4 with the rotation of the cylinder block 4, and a volume of the capacity chamber is changed.

In a suction stroke in which the piston is moved in the cylinder so that the capacity chamber is enlarged, the working oil is sucked into the capacity chamber through the port for sucking. In a discharge stroke in which the piston is moved in the cylinder so that the capacity chamber is contracted, the working oil is discharged to the port for discharge from the capacity chamber.

In the piston pump 1, a stroke amount of the piston can be changed by changing an angle (tilting angle) of the swash plate 3 with respect to the rotation center axis 4C of the cylinder block 4. As a result, a flowrate of the working oil that is discharged from the piston pump 1 can be changed.

When the tilting angle of the swash plate 3 is 0° (zero degrees), that is, when the swash plate 3 is at a neutral position, the piston is not moved with respect to the cylinder block 4 regardless of the rotation of the cylinder block 4. Thus, the volume of the capacity chamber is not changed, and the discharge flowrate of the piston pump 1 is 0 (zero). The working oil is not supplied to the running hydraulic motor, and rotation of the running hydraulic motor is stopped.

The piston pump 1 is a 2-direction discharge type pump, and the port for sucking or discharge of the working oil is switched by switching the tilting direction of the swash plate 3 with the tilting angle 0° as a boundary. By switching the discharge direction of the working oil of the piston pump 1, a rotation direction of the running hydraulic motor is changed, and forward running and reverse running of the vehicle is switched.

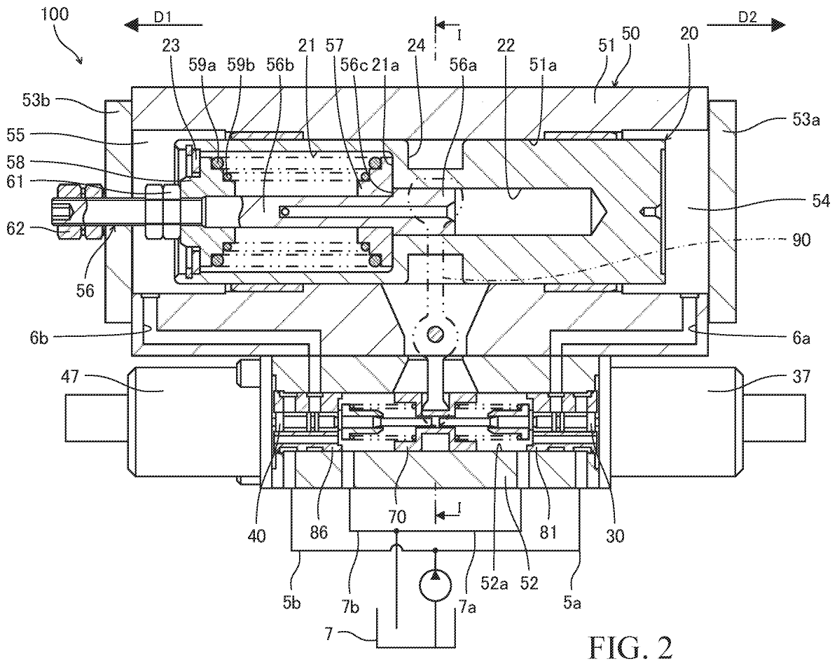

As illustrated in FIGS. 1 and 2, the servo regulator 100 includes a servo piston 20 coupled with the swash plate 3 of the piston pump 1 via an arm 10, and a first spool 30 and a second spool 40 that control the pressure of the working oil acting on the servo piston 20. The first spool 30 and the second spool 40 are moved by a first solenoid 37 and a second solenoid 47, respectively.

The servo piston 20, the first spool 30, and the second spool 40 are accommodated in a case 50. The case 50 has a first case member 51 mounted on the housing 2 of the piston pump 1 and a second case member 52 mounted on the first case member 51.

The first case member 51 is formed with a first accommodating hole 51a, and the second case member 52 is formed with a second accommodating hole 52a. In a state where the second case member 52 is mounted on the first case member 51, the first accommodating hole 51a and the second accommodating hole 52a are substantially in parallel. The servo piston 20 is slidably accommodated in the first accommodating hole 51a, and the first spool 30 and the second spool 40 are accommodated in the second accommodating hole 52a.

Both opening ends of the first accommodating hole 51a are closed by a first cover 53a and a second cover 53b, respectively. An inside of the first accommodating hole 51a is partitioned by the servo piston 20 into a first pressure chamber 54 and a second pressure chamber 55. Specifically, the first pressure chamber 54 is defined by an inner peripheral surface of the first accommodating hole 51a, one end surface of the servo piston 20, and the first cover 53a and is provided to face the one end surface of the servo piston 20. Similarly, the second pressure chamber 55 is defined by the inner peripheral surface of the first accommodating hole 51a, the other end surface of the servo piston 20, and the second cover 53b and is provided to face the other end surface of the servo piston 20.

The servo piston 20 is moved in the first accommodating hole 51a by the pressure of the working oil in the first pressure chamber 54 and the second pressure chamber 55. When the pressure in the first pressure chamber 54 is larger than the pressure in the second pressure chamber 55, the servo piston 20 is moved in a first direction D1 (left direction in FIG. 2) for enlarging the first pressure chamber 54 and for contracting the second pressure chamber 55. When the pressure in the second pressure chamber 55 is larger than the pressure in the first pressure chamber 54, the servo piston 20 is moved in a second direction D2 (right direction in FIG. 2) for enlarging the second pressure chamber 55 and for contracting the first pressure chamber 54.

The servo piston 20 is guided by a guide rod 56 fixed to the second cover 53b. A rod-side end portion of the servo piston 20 is formed with an accommodating recess portion 21 capable of accommodating a first retainer 57 and a second retainer 58 mounted on an outer periphery of the guide rod 56. Moreover, the servo piston 20 is formed with a guide hole 22 extending in an axial direction from a bottom surface 21a of the accommodating recess portion 21.

The guide rod 56 and the servo piston 20 are disposed coaxially. A diameter of a distal end portion 56a of the guide rod 56 is made larger than that of a shaft portion 56b and is slidably inserted into the guide hole 22 of the servo piston 20.

The first retainer 57 and the second retainer 58 are slidably provided on the shaft portion 56b of the guide rod 56. A first piston spring 59a and a second piston spring 59b are provided in a compressed state between the first retainer 57 and the second retainer 58. The first piston spring 59a and the second piston spring 59b bias the servo piston 20 at a neutral position.

As illustrated in FIG. 2, when the servo piston 20 is at the neutral position, the first retainer 57 is brought in contact with the bottom surface 21a of the accommodating recess portion 21 of the servo piston 20 and is brought into contact with a stepped portion 56c formed between the distal end portion 56a of the guide rod 56 and the shaft portion 56b. The second retainer 58 is brought into contact with a stopper ring 23 fixed to an opening end of the accommodating recess portion 21 and is brought into contact with a nut 61 screwed with the shaft portion 56b.

When the servo piston 20 is moved in the first direction D1 from the neutral position, the first retainer 57 is pressed by the bottom surface 21a of the servo piston 20. As a result, the first retainer 57 is moved along the shaft portion 56b of the guide rod 56 so as to be separated from the stepped portion 56c of the guide rod 56.

At this time, the second retainer 58 is brought into contact with the nut 61 and is not moved with respect to the guide rod 56. Therefore, the first piston spring 59a and the second piston spring 59b between the first retainer 57 and the second retainer 58 are compressed, and a spring reaction force for returning the servo piston 20 to the neutral position becomes larger.

On the other hand, when the servo piston 20 is moved in the second direction D2 from the neutral position, the second retainer 58 is pressed by the stopper ring 23 fixed to the servo piston 20. As a result, the second retainer 58 is moved along the shaft portion 56b of the guide rod 56 so as to be separated from the nut 61 screwed with the shaft portion 56b of the guide rod 56.

At this time, the first retainer 57 is brought into contact with the stepped portion 56c of the guide rod 56 and is not moved with respect to the guide rod 56. Therefore, the first piston spring 59a and the second piston spring 59b between the first retainer 57 and the second retainer 58 are compressed, and the spring reaction force for returning the servo piston 20 to the neutral position becomes larger.

The neutral position of the servo piston 20 can be adjusted by adjusting a fastening position of the guide rod 56 to the second cover 53b and by fixing the guide rod 56 to the second cover 53b via a nut 62.

As illustrated in FIGS. 1 and 2, an annular groove 24 is formed on the outer periphery at a center in the axial direction of the servo piston 20. The arm 10 is coupled with the annular groove 24.

Specifically, a pin 12 is provided at a distal end of the arm 10, and a slide metal 13 is rotatably supported by the pin 12. The slide metal 13 is inserted into the annular groove 24 of the servo piston 20.

As described above, the arm 10 is coupled with the annular groove 24 via the pin 12 and the slide metal 13. In FIG. 2, illustration of the arm 10, the pin 12, and the slide metal 13 is omitted.

When the servo piston 20 is moved, the slide metal 13 is moved together with the servo piston 20. As a result, the arm 10 is rotationally moved around the rotational movement center axis 3C, and the swash plate 3 is tilted. As described above, displacement of the servo piston 20 is transmitted to the swash plate 3 via the arm 10. The discharge flowrate of the piston pump 1 is changed by the tilting of the swash plate 3.

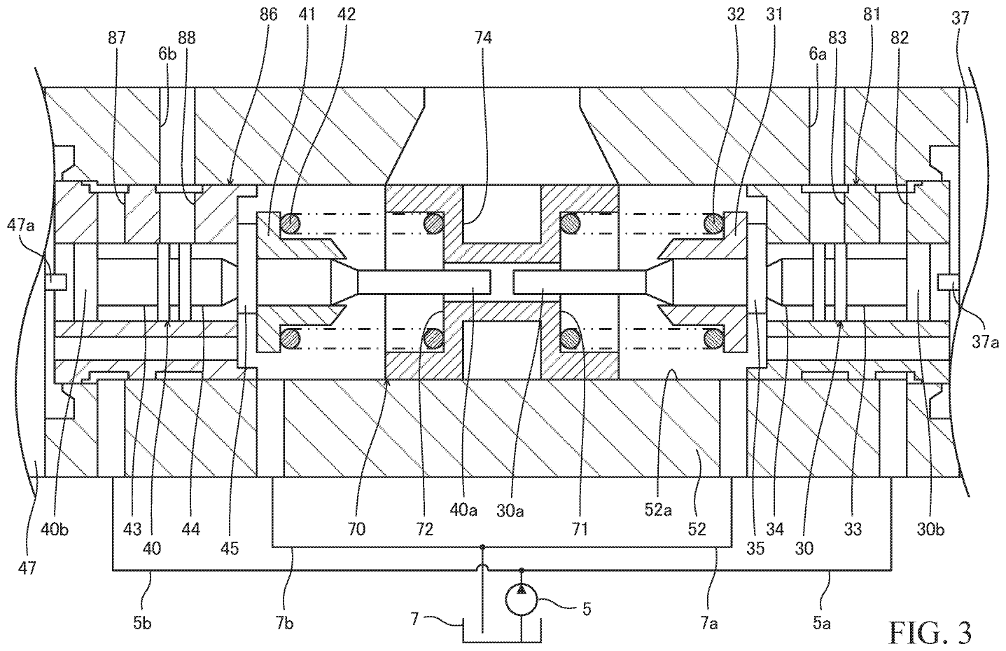

As illustrated in FIGS. 2 and 3, the first spool 30 and the second spool 40 are coaxially disposed in the second accommodating hole 52a of the second case member 52. The first spool 30 controls the pressure in the first pressure chamber 54, and the second spool 40 controls the pressure in the second pressure chamber 55.

A first sleeve 81 and a second sleeve 86 each having a cylindrical shape are provided on both end portions of the second accommodating hole 52a. A base end portion 30b of the first spool 30 is slidably inserted into the first sleeve 81, and a base end portion 40b of the second spool 40 is slidably inserted into the second sleeve 86.

The first sleeve 81 includes a supply port 82 connected to a hydraulic pump (hydraulic pressure source) 5 through a supply passage 5a and a main port 83 connected to the first pressure chamber 54 through a main passage 6a. The second sleeve 86 includes a supply port 87 connected to the hydraulic pump 5 through a supply passage 5b and a main port 88 connected to the second pressure chamber 55 through a main passage 6b.

An inner peripheral surface of the second accommodating hole 52a is formed with openings of drain passages 7a and 7b connected to a tank 7. The openings of the drain passages 7a and 7b are located between the first sleeve 81 and the second sleeve 86.

An outer periphery of the base end portion 30b of the first spool 30 is formed with annular grooves 33 and 34 and a projecting portion 35. The annular groove 33 connects the supply port 82 and the main port 83 in accordance with a position of the first spool 30. The annular groove 34 connects the main port 83 and the drain passage 7a in accordance with the position of the first spool 30.

An outer shape of the projecting portion 35 is formed having a substantially triangular shape so as not to close the opening of the first sleeve 81. Thus, even in a state where the projecting portion 35 is in contact with the first sleeve 81, the annular groove 34 communicates with the drain passage 7a at all times through a space between the projecting portion 35 and the first sleeve 81. FIGS. 2 and 3 illustrate a state where the first spool 30 is disposed so that one of apexes of the substantially triangular shape is located on an upper part of the figure and an opposite side of this apex is located on a lower part of the figure.

An outer periphery of the base end portion 40b of the second spool 40 is formed with annular grooves 43 and 44 and a projecting portion 45. The annular groove 43 connects the supply port 87 and the main port 88 in accordance with a position of the second spool 40. The annular groove 44 connects the main port 88 and the drain passage 7b in accordance with the position of the second spool 40.

An outer shape of the projecting portion 45 is formed having a substantially triangular shape so as not to close the opening of the second sleeve 86. Thus, even in a state where the projecting portion 45 is in contact with the second sleeve 86, the annular groove 44 communicates with the drain passage 7b at all times through a space between the projecting portion 45 and the second sleeve 86. FIGS. 2 and 3 illustrate a state where the second spool 40 is disposed so that one of apexes of the substantially triangular shape is located on an upper part of the figure and an opposite side of this apex is located on a lower part of the figure.

A substantially cylindrical spring holder 70 is provided at a substantially center position of the second accommodating hole 52a. A distal end portion 30a of the first spool 30 and a distal end portion 40a of the second spool 40 are inserted into the spring holder 70.

A first retainer 31 is fixed to the outer periphery at the center in the axial direction of the first spool 30 so as to be brought into contact with the projecting portion 35. A first spool spring (biasing member) 32 is provided in a compressed state between a first spring receiving portion 71 formed on one end side of the spring holder 70 and the first retainer 31. The first spool 30 is biased by the first spool spring 32 to a direction (a right direction in FIGS. 2 and 3) for shutting down communication between the supply port 82 and the main port 83.

A second retainer 41 is fixed to the outer periphery at the center in the axial direction of the second spool 40 so as to be brought into contact with the projecting portion 45. A second spool spring (biasing member) 42 is provided in a compressed state between a second spring receiving portion 72 formed on the other end side of the spring holder 70 and the second retainer 41. The second spool 40 is biased by the second spool spring 42 to a direction (a left direction in FIGS. 2 and 3) for shutting down communication between the supply port 87 and the main port 88.

The first spool 30 is moved by the first solenoid 37, and the second spool 40 is moved by the second solenoid 47. The first solenoid 37 and the second solenoid 47 are proportional solenoids having a thrust (suction force) of a plunger changed in proportion with a given current value. The first solenoid 37 and the second solenoid 47 are mounted on the second case member 52 so as to close an opening end of the second accommodating hole 52a. The first solenoid 37 and the second solenoid 47 are connected to a controller, not shown, via a wiring, respectively.

The first spool 30 is moved against a reaction force of the first spool spring 32 by being pressed by a first plunger 37a of the first solenoid 37. The second spool 40 is moved against the reaction force of the second spool spring 42 by being pressed by a second plunger 47a of the second solenoid 47.

When the first solenoid 37 and the second solenoid 47 are in a non-driven state, the first spool 30 and the second spool 40 are located at initial positions. At this time, the first spool 30 is stopped in a state where the projecting portion 35 is in contact with an inner-side end surface of the first sleeve 81, and an end surface of the first spool 30 and a distal end of the first plunger 37a of the first solenoid 37 are faced with each other with a predetermined interval (initial interval) between them. Moreover, the second spool 40 is stopped in a state where the projecting portion 45 is in contact with an inner-side end surface of the second sleeve 86, and an end surface of the second spool 40 and a distal end of the second plunger 47a of the second solenoid 47 are faced with each other with a predetermined interval (initial interval) between them.

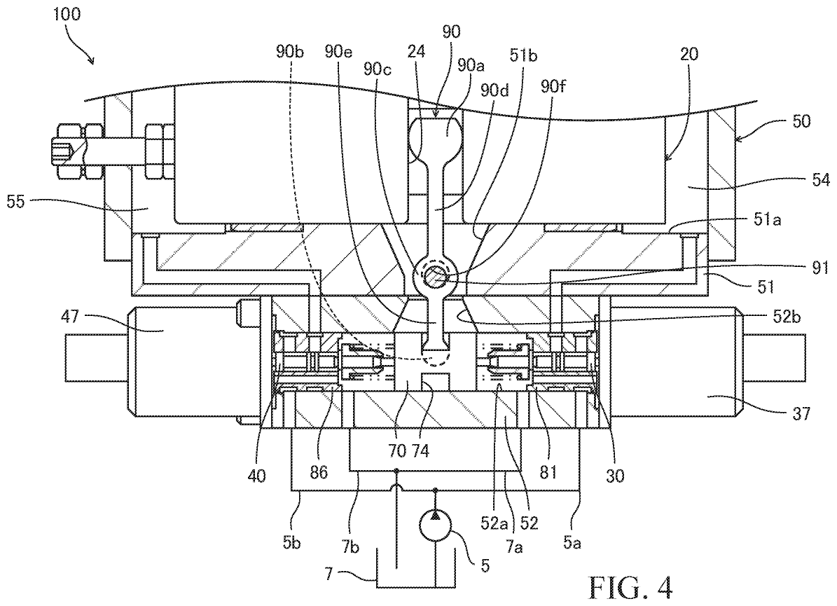

As illustrated in FIGS. 1 and 4, the servo regulator 100 further includes a feedback link (feedback portion) 90 that transmits displacement of the servo piston 20 to the spring holder 70 and a support shaft 91 that rotatably supports the feedback link 90.

The feedback link 90 extends between the servo piston 20 and the spring holder 70. Specifically, the first case member 51 is formed with a first insertion hole 51b opened in the inner peripheral surface of the first accommodating hole 51a, and the second case member 52 is formed with a second insertion hole 52b opened in the inner peripheral surface of the second accommodating hole 52a. The first insertion hole 51b and the second insertion hole 52b continue to each other, and the feedback link 90 extends between the servo piston 20 and the spring holder 70 through the first insertion hole 51b and the second insertion hole 52b.

The second case member 52 is formed detachably to the first case member 51 along the axial direction of the feedback link 90. Thus, an opening of the second insertion hole 52b can be made smaller, and a sealing performance between the first case member 51 and the second case member 52 can be improved.

A first end portion 90a of the feedback link 90 is inserted into the annular groove 24 of the servo piston 20. As a result, the feedback link 90 is coupled with the servo piston 20.

The first end portion 90a of the feedback link 90 is located on a side opposite to the slide metal 13 with respect to the center axis of the servo piston 20. Moreover, the feedback link 90 extends in a tangent direction of the annular groove 24, and a part of the feedback link 90 is disposed in the annular groove 24 so as to cross the servo piston 20.

A second end portion 90b of the feedback link 90 is coupled with the spring holder 70. Specifically, an outer periphery of the spring holder 70 is formed with an annular groove 74, and the second end portion 90b is inserted into the annular groove 74.

As described above, the feedback link 90 is coupled with the servo piston 20 and also coupled with the spring holder 70. Since the servo piston 20 is coupled with the swash plate 3 via the arm 10, the feedback link 90 is coupled with the swash plate 3 via the servo piston 20 and the arm 10. Similarly, the spring holder 70 is coupled with the swash plate 3 via the feedback link 90, the servo piston 20, and the arm 10.

The first spool 30 and the second spool 40 are provided on a side opposite to the servo piston 20 with respect to the feedback link 90. Since the first spool 30 and the second spool 40 are accommodated in the second case member 52, the second case member 52 can be detachably attached to the first case member 51 without being influenced by the feedback link 90. For example, the second case member 52 can be detachably attached from a lower direction in FIG. 1.

The feedback link 90 is provided on the side opposite to the arm 10 with respect to the servo piston 20. Thus, the feedback link 90 can be detachably attached to the case 50 without being influenced by the servo piston 20. For example, in a state where the second case member 52 is removed from the first case member 51, the feedback link 90 can be detachably attached to the first case member 51 from the lower direction in FIG. 1.

Moreover, the feedback link 90 has an intermediate portion 90c located between the first end portion 90a and the second end portion 90b, a coupling portion 90d that couples the first end portion 90a and the intermediate portion 90c, and a coupling portion 90e that couples the second end portion 90b and the intermediate portion 90c. The intermediate portion 90c is formed with a hole 90f.

The support shaft 91 is fixed to the first case member 51 in a state inserted into the hole 90f of the feedback link 90. In other words, the feedback link 90 supported by the first case member 15 via the support shaft 91, capable of rotational movement. Therefore, in a state where the feedback link 90 is supported by the first case member 51, the second case member 52 can be assembled to the first case member 51.

Since the servo piston 20 and the spring holder 70 are coupled via the feedback link 90, when the servo piston 20 is moved and the feedback link 90 is rotationally moved, the spring holder 70 is moved in a direction opposite to a moving direction of the servo piston 20.

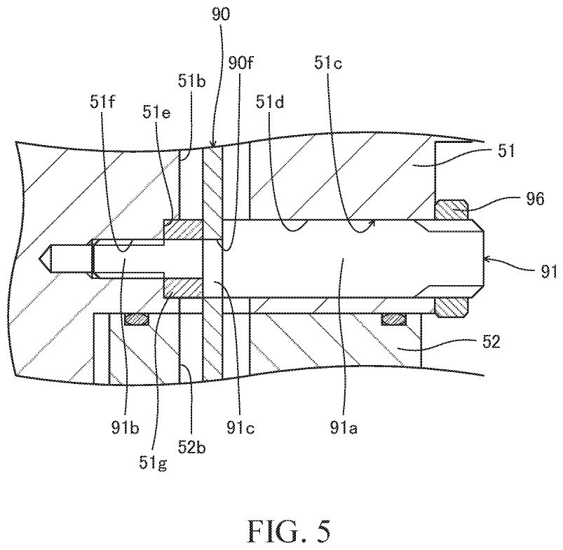

As illustrated in FIG. 5, the support shaft 91 is fixed to a hole 51c formed in the first case member 51. The hole 15c has a first hole portion 51d opened in a side surface of the first case member 51 and a second hole portion 51f opened in a bottom surface 51e of the first hole portion 51d.

The first hole portion 51d crosses the first insertion hole 51b of the first case member 51. The second hole portion 51f is formed coaxially with the first hole portion 51d, and a female screw is formed on an inner periphery of the second hole portion 51f. A bush 51g is disposed on the bottom surface 51e of the first hole portion 51d. An outer diameter of the bush 51g is substantially equal to an inner diameter of the first hole portion 51d, and an inner diameter of the bush 51g is substantially equal to an inner diameter of the second hole portion 51f. The outer diameter of the bush 51g does not have to be equal to the inner diameter of the first hole portion 51d but only needs to be such a size that can be inserted into the first hole portion 51d.

The support shaft 91 has a base portion 91a inserted through the first hole portion 51d, a distal end portion 91b formed coaxially with the base end portion 91a, and an eccentric portion 91c made eccentric to the base portion 91a and the distal end portion 91b. An outer diameter of the distal end portion 91b is smaller than an outer diameter of the base portion 91a. The outer diameter of the eccentric portion 91c is smaller than the outer diameter of the base portion 91a and is larger than the outer diameter of the distal end portion 91b.

The outer periphery of the distal end portion 91b is formed with a male screw and is screwed with the female screw of the second hole portion 51f. The base portion 91a protrudes to an outer side of the first case member 51 from the first hole portion 51d. The outer periphery of the base portion 91a is formed with a male screw, and a fixing nut 96 is screwed with the outer periphery of the base portion 91a. The support shaft 91 is fixed to the first case member 51 by tightening the fixing nut 96 in a state where the female screw of the second hole portion 51f is screwed with the male screw of the distal end portion 91b.

The eccentric portion 91c is provided between the base portion 91a and the distal end portion 91b and is located in the first insertion hole 51b of the first case member 51. An outer diameter of the eccentric portion 91c is substantially equal to an inner diameter of the hole 90f of the feedback link 90, and the eccentric portion 91c is inserted into the hole 90f. That is, the feedback link 90 is supported capable of rotational movement around a center axis of the eccentric portion 91c.

As described above, the eccentric portion 91c is eccentric to the base portion 91a and the distal end portion 91b. Thus, when the support shaft 91 is rotated with respect to the first case member 51, the center of the eccentric portion 91c is displaced. As a result, the center of the hole 90f of the feedback link 90, that is, the rotational movement center axis of the feedback link 90 is displaced.

As illustrated in FIG. 4, the feedback link 90 is coupled with the servo piston 20 and the spring holder 70. Thus, the servo piston 20 and the spring holder 70 are displaced with the displacement of the rotational movement center of the feedback link 90.

Spring constants of the first piston spring 59a and the second piston spring 59b (see FIG. 2) is larger than spring constants of the first spool spring 32 and the second spool spring 42 (see FIG. 3) held by the spring holder 70. Thus, a displacement amount of the servo piston 20 is smaller than the displacement amount of the spring holder 70. That is, the displacement of the rotational movement center of the feedback link 90 mainly causes the displacement of the spring holder 70. The displacement of the spring holder 70 causes the first spool spring 32 and the second spool spring 42 to be moved, and the neutral positions of the first spool 30 and the second spool 40 to be changed.

As described above, in the servo regulator 100, the neutral positions of the first spool 30 and the second spool 40 can be adjusted by rotating the support shaft 91.

Subsequently, an operation of the servo regulator 100 will be described by referring to FIGS. 1 to 4 and FIG. 6.

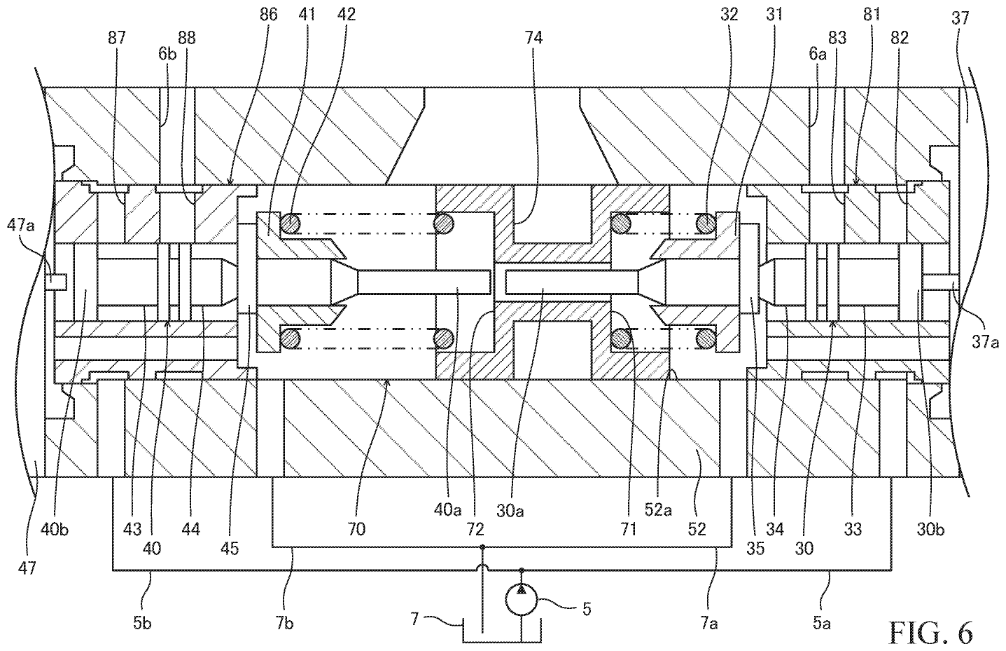

When a driver operates a control lever of the vehicle so that the vehicle goes forward, a current according to the operation amount of the control lever is given to the first solenoid 37, and the first plunger 37a of the first solenoid 37 moves the first spool 30 at the initial position (see FIG. 6).

As illustrated in FIGS. 2 and 6, when the first spool 30 is moved by the first plunger 37a, the annular groove 33 of the first spool 30 connects the supply port 82 and the main port 83 to each other. The working oil that is discharged from the hydraulic pump 5 is led to the first pressure chamber 54 through the supply port 82, the annular groove 33, the main port 83, and the main passage 6a.

At this time, the second solenoid 47 is in a non-driven state, and a thrust of the second solenoid 47 does not act on the second spool 40. In this state, the main port 88 communicates with the annular groove 44 of the second spool 40. Since the annular groove 44 communicates with the drain passage 7b at all times through a space between the projecting portion 45 and the second sleeve 86, the main port 88 communicates with the drain passage 7b through the annular groove 44. That is, the second spool 40 connects the main port 88 and the drain passage 7b to each other while shutting down communication between the supply port 87 and the main port 88. Thus, the tank pressure is led to the second pressure chamber 55 through the drain passage 7b and the main port 88.

Since a pilot pressure is led to the first pressure chamber 54 and the tank pressure is led to the second pressure chamber 55, the servo piston 20 is moved in the first direction D1 from the neutral position against the biasing forces of the first piston spring 59a and the second piston spring 59b. Since the slide metal 13 (see FIG. 1) is inserted into the annular groove 24 of the servo piston 20, the slide metal 13 (see FIG. 1) is moved in the first direction D1, and the arm 10 is rotationally moved.

With the rotational movement of the arm 10, the swash plate 3 of the piston pump 1 is tilted to one side, and the tilting angle of the swash plate 3 is changed. As a result, the working oil is supplied to the running motor from the piston pump 1, and the running hydraulic motor is rotated forward, and the vehicle goes forward.

As illustrated in FIG. 4, since the first end portion 90a of the feedback link 90 is inserted into the annular groove 24 of the servo piston 20, when the servo piston 20 is moved in the first direction D1, the first end portion 90a is moved in the first direction D1. The feedback link 90 is rotationally moved by the movement of the first end portion 90a, and the second end portion 90b of the feedback link 90 is moved. As a result, as illustrated in FIG. 6, the spring holder 70 compresses the first spool spring 32, and the reaction force (biasing force) of the first spool spring 32 for returning the first spool 30 to the initial position becomes larger.

As described above, the feedback link 90 changes the biasing force of the first spool spring 32 in accordance with the movement of the servo piston 20, that is, the change in the tilting angle of the swash plate 3.

When the biasing force of the first spool spring 32 is changed, the first spool 30 is moved so that the biasing force of the first spool spring 32 and the thrust of the first plunger 37a of the first solenoid 37 is balanced. As a result, the pressure in the first pressure chamber 54 is adjusted so as to hold the servo piston 20 at the desired position. As a result, the tilting angle of the swash plate 3 of the piston pump 1 is maintained at the desired angle.

On the other hand, when the driver operates the control lever so that the vehicle goes backward, the current according to the operation amount of the control lever is given to the second solenoid 47, and the second plunger 47a of the second solenoid 47 moves the second spool 40.

When the second spool 40 is moved by the second plunger 47a, the annular groove 43 of the second spool 40 connects the supply port 87 and the main port 88. The working oil that is discharged from the hydraulic pump 5 is led to the second pressure chamber 55 through the supply port 87, the annular groove 43, the main port 88, and the main passage 6b.

At this time, the first solenoid 37 is in the non-driven state, and the thrust of the first solenoid 37 does not act on the first spool 30. In this state, the main port 83 communicates with the annular groove 34 of the first spool 30. Since the annular groove 34 communicates with the drain passage 7a through the space between the projecting portion 35 and the first sleeve 81 at all times, the main port 83 communicates with the drain passage 7a through the annular groove 34. That is, the first spool 30 connects the main port 83 and the drain passage 7a to each other, while shutting down communication between the supply port 82 and the main port 83. Thus, the tank pressure is led to the first pressure chamber 54 through the drain passage 7a and the main port 83.

Since a pilot pressure is led to the second pressure chamber 55 and the tank pressure is led to the first pressure chamber 54, the servo piston 20 is moved in the second direction D2 from the neutral position in FIG. 2 against the biasing forces of the first piston spring 59a and the second piston spring 59b. The slide metal 13 (see FIG. 1) is moved in the second direction D2, and the arm 10 is rotationally moved. As a result, the swash plate 3 of the piston pump 1 is tilted to the other, the running hydraulic motor is rotated reversely, and the vehicle goes backward.

Since the first end portion 90a of the feedback link 90 is inserted into the annular groove 24 of the servo piston 20, when the servo piston 20 is moved in the second direction D2, the first end portion 90a of the feedback link 90 is moved in the second direction D2. The feedback link 90 is rotationally moved by the movement of the first end portion 90a, and the second end portion 90b of the feedback link 90 is moved. As a result, the spring holder 70 compresses the second spool spring 42, and the reaction force (biasing force) of the second spool spring 42 for returning the second spool 40 to the initial position becomes larger.

Then, the second spool 40 is moved by the biasing force of the second spool spring 42, and the pressure in the second pressure chamber 55 is adjusted to hold the servo piston 20 at the desired position. As a result, the tilting angle of the swash plate 3 of the piston pump 1 is maintained at the desired angle.

According to the servo regulator 100, the first spool 30 and the second spool 40 are driven by the first solenoid 37 and the second solenoid 47, and the pressure in the first pressure chamber 54 and the second pressure chamber 55 is controlled so as to change the position of the servo piston 20, whereby the tilting of the swash plate 3 of the piston pump 1 can be controlled.

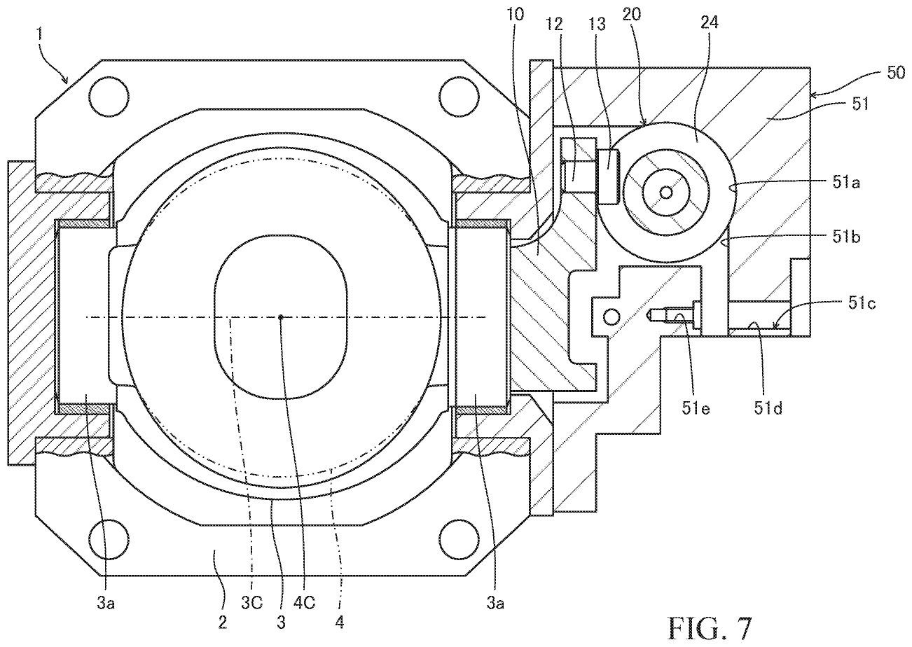

Subsequently, an assembling method of the servo regulator 100 to the piston pump 1 will be described by referring to FIGS. 7 to 9.

First, as illustrated in FIG. 7, the servo piston 20 is inserted into the first accommodating hole 51a of the first case member 51, and the first case member 51 is mounted on the housing 2 of the piston pump 1. At this time, the slide metal 13 of the arm 10 is inserted into the annular groove 24 of the servo piston 20. As a result, the servo piston 20 is coupled with the swash plate 3 of the piston pump 1 via the slide metal 13 and the arm 10.

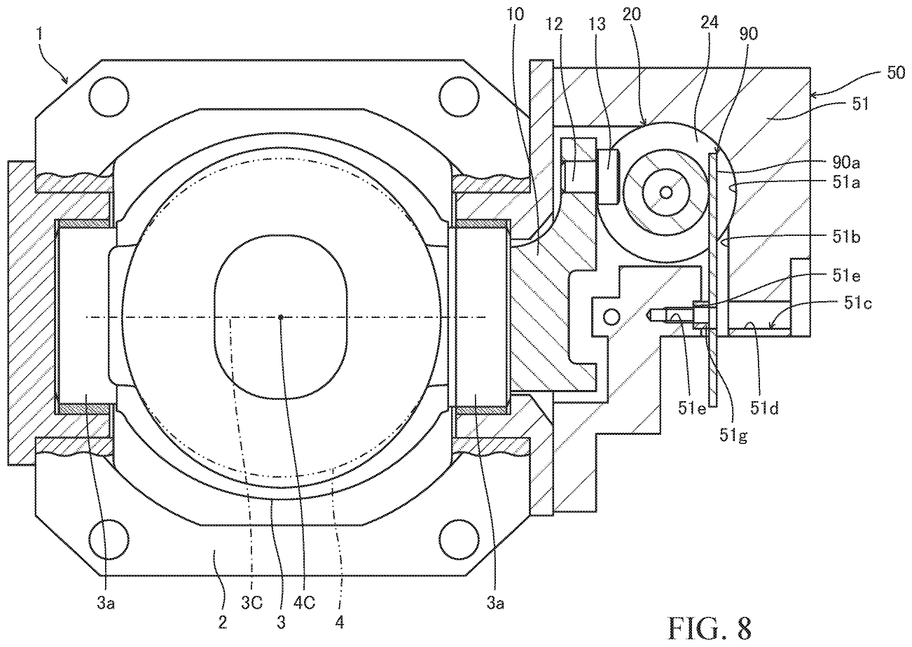

Subsequently, as illustrated in FIG. 8, the bush 51g is disposed on the bottom surface 51e of the first hole portion 51d. After that, the feedback link 90 is inserted into the first insertion hole 51b of the first case member 51, and the first end portion 90a of the feedback link 90 is inserted into the annular groove 24 of the servo piston 20. As a result, the feedback link 90 is coupled with the swash plate 3 via the servo piston 20.

At this time, since the feedback link 90 only needs to be inserted into the annular groove 24, there is no need to position the circumferential position of the servo piston 20. Therefore, the feedback link 90 can be easily coupled with the servo piston 20.

Moreover, when the feedback link 90 is inserted into the annular groove 24, the feedback link 90 is moved along the tangent direction of the annular groove 24, and the feedback link 90 is inserted into the annular groove 24 so as to cross the servo piston 20. The movement of the feedback link 90 is not limited by the bottom surface of the annular groove 24, but the feedback link 90 can be inserted until it touches the inner peripheral surface of the first accommodating hole 51a of the first case member 51. Therefore, even if the dimensional accuracy of the feedback link 90 is low, the feedback link 90 and the servo piston 20 can be coupled.

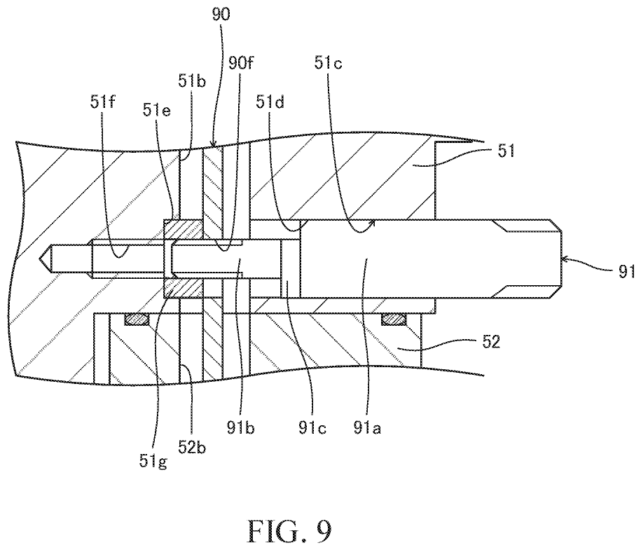

Subsequently, as illustrated in FIG. 9, the supporting shaft 91 is inserted into the hole 51c of the first case member 51. At this time, the distal end portion 91b is inserted into the hole 90f of the feedback link 90 and is inserted into the bush 51g.

Subsequently, the distal end portion 91b is pushed into the second hole portion 51f. As a result, the eccentric portion 91c of the support shaft 91 is moved toward the hole 90f of the feedback link 90. As a result, the eccentric portion 91c is inserted into the hole 90f (see FIG. 5), and the feedback link 90 is supported by the first case member 51 via the support shaft 91, capable of rotational movement. By screwing the fixing nut 96 with the outer periphery of the base portion 91a, the support shaft 91 is fixed to the first case member 51.

Subsequently, the second case member 52 is mounted on the first case member 51. At this time, the feedback link 90 is inserted into the second insertion hole 52b of the second case member 52, and the second end portion 90b of the feedback link 90 is inserted into the annular groove 74 of the spring holder 70. As a result, the feedback link 90 is coupled with the spring holder 70.

As described above, assembling of the servo regulator 100 to the piston pump 1 is completed.

When at least one of the first spool 30, the second spool 40, the first spool spring 32 and the second spool spring 42 is replaced, the first solenoid 37 or the second solenoid 47 is removed from the second case member 52. After that, the first spool 30, the second spool 40, the first spool spring 32 and the second spool spring 42 are pulled out of the second accommodating hole 52a of the second case member 52. At this time, the second case member 52 may be mounted on the first case member 51 or may be removed from the first case member 51. The first case member 51 is mounted on the housing 2 of the piston pump 1 regardless of the mounting state of the second case member 52. Since the servo piston 20 is accommodated in the first case member 51, coupling between the servo piston 20 and the swash plate 3 can be maintained.

As described above, in the servo regulator 100, at least any one of the first spool 30, the second spool 40, the first spool spring 32, and the second spool spring 42 can be replaced without cancelling coupling between the servo piston 20 and the swash plate 3. Therefore, usability of the servo regulator 100 can be improved.

Moreover, when the second case member 52 is removed from the first case member 51, the feedback link 90 can be pulled out of the second insertion hole 52b of the second case member 52. Therefore, at least any one of the first spool 30, the second spool 40, the first spool spring 32, and the second spool spring 42 can be replaced in the state where the feedback link 90 and the servo piston 20 are coupled, and usability of the servo regulator 100 can be improved.

Hereinafter, the constitution, actions, and effects of the embodiment of the present invention will be described in summary.

This embodiment relates to the servo regulator 100 that controls tilting of the swash plate 3 of the piston pump 1. The servo regulator 100 includes the servo piston 20 slidably accommodated in the case 50 and coupled with the swash plate 3, the first pressure chamber 54 and the second pressure chamber 55 provided to face the end portion of the servo piston 20, the first spool 30 and the second spool 40 configured to be moved by the first solenoid 37 and the second solenoid 47 and to control the pressures in the first pressure chamber 54 and the second pressure chamber 55, the first spool spring 32 and the second spool spring 42 configured to bias the first spool 30 and the second spool 40 against the thrust of the first solenoid 37 and the second solenoid 47, and the feedback link 90 configured to change the biasing force of the first spool spring 32 and the second spool spring 42 in accordance with the tilting of the swash plate 3, and the feedback link 90 is coupled with the swash plate 3 via the servo piston 20.

In this constitution, the feedback link 90 is coupled with the swash plate 3 via the servo piston 20. Thus, when the servo regulator 100 is assembled to the piston pump 1, the feedback link 90 only needs to be coupled with the servo piston 20 before or after the servo piston 20 and the swash plate 3 are coupled. Therefore, the servo regulator 100 can be assembled easily to the piston pump 1.

Moreover, the outer peripheral surface of the servo piston 20 is formed with the annular groove 24 into which the feedback link 90 is inserted.

In this constitution, the annular groove 24 into which the feedback link 90 is inserted is formed on the outer peripheral surface of the servo piston 20. Thus, when the servo regulator 100 is assembled, the feedback link 90 and the servo piston 20 can be coupled by inserting the feedback link 90 in the annular groove 24 without positioning the circumferential position of the servo piston 20. Therefore, an assembling performance of the servo regulator 100 can be improved.

Moreover, the feedback link 90 extends in the tangent direction of the annular groove 24.

In this constitution, the feedback link 90 extends in the tangent direction of the annular groove 24. Thus, when the feedback link 90 is moved along the extending direction of it and inserting the feedback link 90 into the annular groove 24, the feedback link 90 can be inserted until it touches the inner peripheral surface of the case 50. Therefore, even if the dimensional accuracy of the feedback link 90 is low, the feedback link 90 and the servo piston 20 can be coupled, and the assembling performance of the servo regulator 100 can be improved.

Moreover, the case 50 has the first case member 51 mounted on the piston pump 1 and configured to accommodate the servo piston 20 and the second case member 52 mounted on the first case member 51 and configured to accommodate the first spool 30, the second spool 40, the first spool spring 32, and the second spool spring 42.

In this constitution, the servo piston 20 is accommodated in the first case member 51, and the first spool 30 and the second spool 40 are accommodated in the second case member 52 mounted on the first case member 51. Thus, the second case member 52 can be detachably attached to the first case member 51 in the state where the servo piston 20 and the swash plate 3 are coupled with each other, and the assembling performance of the servo regulator 100 can be improved. Moreover, since the first spool 30, the second spool 40, the first spool spring 32, and the second spool spring 42 are accommodated in the second case member 52, the first spool 30, the second spool 40, the first spool spring 32, and the second spool spring 42 can be easily replaced by removing the second case member 52 from the first case member 51, and usability of the servo regulator 100 can be improved.

Moreover, the feedback link 90 is inserted into the second insertion hole 52b formed in the second case member 52, and the second case member 52 is detachably attached to the first case member 51 along the second insertion hole 52b.

In this constitution, the second case member 52 is detachably attached to the first case member 51 along the second insertion hole 52b. Thus, when the second case member 52 is assembled to the first case member 51, the feedback link 90 can be assembled along the second insertion hole 52b of the second case member 52, and the assembling performance of the servo regulator 100 can be improved. Moreover, the first spool 30, the second spool 40, the first spool spring 32, and the second spool spring 42 can be replaced in the state where the feedback link 90 and the servo piston 20 are coupled, and usability of the servo regulator 100 can be improved.

Moreover, the second case member 52 is detachably attached to the first case member 51 along the axial direction of the feedback link 90.

In this constitution, the second case member 52 can be detachably attached to the first case member 51 along the axial direction of the feedback link 90. Thus, the opening of the second insertion hole 52b of the second case member 52 can be made smaller, and a sealing performance between the first case member 51 and the second case member 52 is improved.

Moreover, the first spool 30 and the second spool 40 are provided on the side opposite to the servo piston 20 with respect to the feedback link 90.

In this constitution, the first spool 30 and the second spool 40 are provided on the side opposite to the servo piston 20 with respect to the feedback link 90. Since the first spool 30 and the second spool 40 are accommodated in the second case member 52, the second case member 52 can be detachably attached to the first case member without being influenced by the feedback link 90. For example, the second case member 52 can be removed from the first case member 51 to the lower direction in FIG. 1.

Moreover, the servo regulator 100 further includes the support shaft 91 configured to support the feedback link 90, capable of rotational movement, and the support shaft 91 is provided on the first case member 51.

In this constitution, the support shaft 91 is provided on the first case member 51. Thus, the feedback link 90 is supported by the first case member 51 via the support shaft 91. Therefore, the second case member 52 can be assembled in the state where the feedback link 90 is supported by the first case member 51, and the assembling performance of the servo regulator 100 is improved. Moreover, the second case member 52 can be removed from the first case member 51 without removing the feedback link 90 from the first case member 51.

Moreover, the servo regulator 100 further includes the arm 10 coupling the swash plate 3 and the servo piston 20, and the feedback link 90 is provided on the side opposite to the arm 10 with respect to the servo piston 20.

In this constitution, the feedback link 90 is provided on the side opposite to the arm 10 with respect to the servo piston 20. Thus, the feedback link 90 can be detachably attached to the first case member 51 without being influenced by the servo piston 20. For example, the feedback link 90 can be detachably attached to the first case member 51 from the lower direction in FIG. 1.

Although the embodiment of the present invention has been described above, the above embodiment is merely an illustration of one exemplary application of the present invention and is not intended to limit the technical scope of the present invention to the specific configuration of the above embodiment.

In the aforementioned embodiment, the feedback link 90 is coupled with the servo piston 20 after the servo piston 20 is coupled with the swash plate 3, but the feedback link 90 may be coupled with the servo piston 20 before the servo piston 20 is coupled with the swash plate 3.

The present application claims a priority based on Japanese Patent Application No. 2017-047564 filed with the Japan Patent Office on Mar. 13, 2017, and all the contents of this application are incorporated herein by reference.

1. A servo regulator for controlling tilting of a swash plate of a variable volume piston pump, comprising:
a servo piston slidably accommodated in a case and coupled with the swash plate;
a pressure chamber provided to face an end portion of the servo piston;
a spool configured to control a pressure in the pressure chamber by being moved by a solenoid;
a biasing member configured to bias the spool against a thrust of the solenoid; and
a feedback portion configured to change a biasing force of the biasing member in accordance with the tilting of the swash plate, wherein
the feedback portion is coupled with the swash plate via the servo piston.

2. The servo regulator according to claim 1, wherein
an outer peripheral surface of the servo piston is formed with an annular groove into which the feedback portion is inserted.

3. The servo regulator according to claim 2, wherein
the feedback portion extends in a tangent direction of the annular groove.

4. The servo regulator according to claim 1, wherein
the case includes:
a first case member mounted on the variable volume piston pump, the first case being configured to accommodate the servo piston; and
a second case member mounted on the first case member, the second case member being configured to accommodate the spool and the biasing member.

5. The servo regulator according to claim 4, wherein
the feedback portion inserts an insertion hole formed in the second case member; and
the second case member is detachably attached to the first case member along the insertion hole.

6. The servo regulator according to claim 4, wherein
the second case member is detachably attached to the first case member along an axial direction of the feedback portion.

7. The servo regulator according to claim 4, wherein
the spool is provided on a side opposite to the servo piston with respect to the feedback portion.

8. The servo regulator according to claim 4, further comprising
a support shaft configured to support the feedback portion, capable of rotational movement, wherein
the support shaft is provided on the first case member.

9. The servo regulator according to claim 1, further comprising
an arm configured to couple the swash plate and the servo piston, wherein
the feedback portion is provided on a side opposite to the arm with respect to the servo piston.

10. The servo regulator according to claim 3, wherein
the case includes:
a first case member mounted on the variable volume piston pump, the first case being configured to accommodate the servo piston; and
a second case member mounted on the first case member, the second case member being configured to accommodate the spool and the biasing member.

11. The servo regulator according to claim 10, further comprising
an arm configured to couple the swash plate and the servo piston, wherein
the feedback portion is provided on a side opposite to the arm with respect to the servo piston.
